(19) United States
(12) Patent Application Publication
(10) Pub. No.: US 2009/0213620 A1
(43) Pub. Date: Aug. 27, 2009

(54) Lamp with Shunt Compression Spring

(76) Inventor: Hung-Wen Lee, Chu Pei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/036,344

(22) Filed: Feb. 25, 2008

(51) Int. Cl. H01R 33/06

(52) U.S. Cl. 362/653

(57) ABSTRACT

A lamp with shunt compressing spring has a socket, two electrodes, a shunt compression spring, an insulating casing, a sliding lid, a bulb holder and a bulb. The shunt compression spring is mounted in the socket and has two electric contacting ends contacting selectively and respectively with the electrodes. The insulating casing covers the shunt compression spring and has a first and a second through openings respectively exposing the electric contacting ends of the shunt compression spring. The sliding lid connects movably to the insulating casing, corresponds to the first through opening of the insulating casing and exposes the corresponding electric contacting end of the shunt compression spring. The bulb holder has a protrusion pressing the sliding lid to compress the shunt compression spring and keep the electric contacting end of the shunt compression spring exposing through the sliding lid from contacting with the corresponding electrode.

### BACKGROUND OF THE INVENTION

1. Field of the Invention

The present invention relates to a lamp, and more particularly to a lamp that keeps electric connection of the light string with a shunt compression spring even a light bulb is removed from a socket of the lamp when the lamp is used in a light string.

2. Description of Related Art

Light strings are commonly used for decoration during holidays. In general, each light string has multiple lamps electronically connected in series to ensure that all lamps emit lights with the same illumination because the same current flowing through lamps connected in series is well known.

However, if a bulb in one of the lamps is removed from the socket of the same lamp, other lamps electronically connected in series in the light string will not emit lights because the current loop is cut off. Therefore, a conventional lamp with shunt terminals is used to overcome the above drawback.

With reference to FIG. 9, the conventional lamp with shunt terminals comprises a socket (91), a bulb holder (92), two shunt terminals (95), a protrusion (96), a bulb (93) and two electrodes (94). The socket (91) has an inner surface and a bottom. The bulb holder (92) is mounted in the socket (91) and has a bottom. The shunt terminals (95) are mounted oppositely on the inner surface of the socket (91) and are contactably separated by the bulb holder (92). The protrusion (96) is formed downwardly from the bottom of the bulb holder (92) to separate the shunt terminals (95) auxiliarily from each other when the bulb holder (92) is plugged in the socket (91). The bulb (93) is mounted in the bulb holder (92), protrudes from the bulb holder (92) and the socket (91) and has two wires (931). The wires (931) of the bulb (93) protrude from the bulb (93) and pass oppositely through the bulb holder (92) to make electrical contact respectively with the shunt terminals (95). The electrodes (94) protrude from the bottom of the socket (91) and contact respectively with the shunt terminals (95).

With further reference to FIG. 10, when the conventional lamp with shunt terminals is used in a light string and the bulb (93) and the bulb holder (92) are removed from the socket (91) together, the shunt terminals (95) will contact with each other. Therefore, the current loop of the light string is maintained because the shunt terminals (95) contact respectively with the electrodes (94) and contact with each other.

However, the above lamp with the shunt terminals (95) does not ensure that the current loop is maintained when the bulb (93) is removed from the bulb holder (92) because the shunt terminals (95) do not prevent from being deformed. Once one of the shunt terminals (95) is deformed, the two shunt terminals (95) will no longer contact with each other and the deformed shunt terminals do not ensure the current loop maintaining.

To overcome the shortcomings, the present invention provides a lamp with shunt compression spring to mitigate or obviate the aforementioned problems.

### SUMMARY OF THE INVENTION

The main objective of the invention is to provide a lamp that keeps electric connection of the light string with a shunt compression spring even a light bulb is out of a socket of the lamp when the lamp is used in a light string.

The lamp in accordance with the present invention comprises a socket, two electrodes, a shunt compression spring, an insulating casing, a sliding lid, a bulb holder and a bulb. The shunt compression spring is mounted in the socket and has two electric contacting ends contacting selectively and respectively with the electrodes. The insulating casing covers the shunt compression spring and has a first and a second through openings respectively exposing the electric contacting ends of the shunt compression spring. The sliding lid connects movably to the insulating casing, corresponding to the first through opening of the insulating casing and exposes the corresponding electric contacting end of the shunt compression spring. The bulb holder has a protrusion pressing the sliding lid to compress the shunt compression spring and keep the electric contacting end of the shunt compression spring exposing through the sliding lid from contacting with the corresponding electrode. The bulb has two wires passing through oppositely through the bulb holder to make electrical contact respectively with the electrodes.

Other objectives, advantages and novel features of the invention will become more apparent from the following detailed description when taken in conjunction with the accompanying drawings.

### BRIEF DESCRIPTION OF THE DRAWING

FIG. 1 is an explosively perspective view of a first embodiment of a lamp in accordance with the present invention;

FIG. 2 is a front view in partial section of the first embodiment of the lamp in accordance with the present invention;

FIG. 3A is a perspective view of a shunt compression spring covered by an insulating casing and a sliding lid in the lamp in FIG. 2;

FIG. 3B is a perspective view in partial section of the shunt compression spring covered by the insulating casing and the sliding lid in FIG. 3A;

FIG. 4 is an operationally front view in partial section of the lamp in FIG. 2;

FIG. 5A is a perspective view of a shunt compression spring covered by an insulating casing and a sliding lid in a second embodiment of a lamp in accordance with the present invention;

FIG. 5B is a perspective view in partial section of the shunt compression spring covered by the insulating casing and the sliding lid in FIG. 5A;

FIG. 6A is a perspective view of a shunt compression spring covered by an insulating casing and a sliding lid in a third embodiment of a lamp in accordance with the present invention;

FIG. 6B is a perspective view in partial section of the shunt compression spring covered by the insulating casing and the sliding lid in FIG. 6A;

FIG. 7 is a front view in partial section of the fourth embodiment of a lamp in accordance with the present invention;

FIG. 8 is an operationally front section view in partial section of the lamp in FIG. 7;

FIG. 9 is a partially cross sectional view of a conventional lamp with shunt terminals; and

FIG. 10 an operationally and partially cross sectional view of the conventional lamp in FIG. 9.

### DETAILED DESCRIPTION OF PREFERRED EMBODIMENT

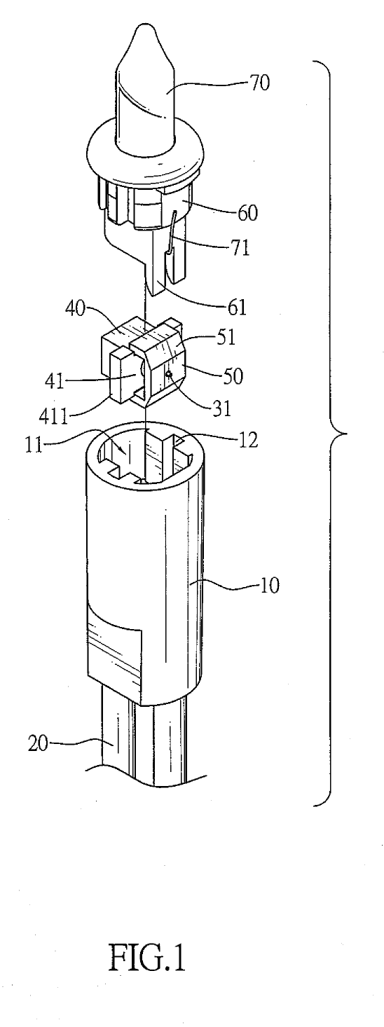

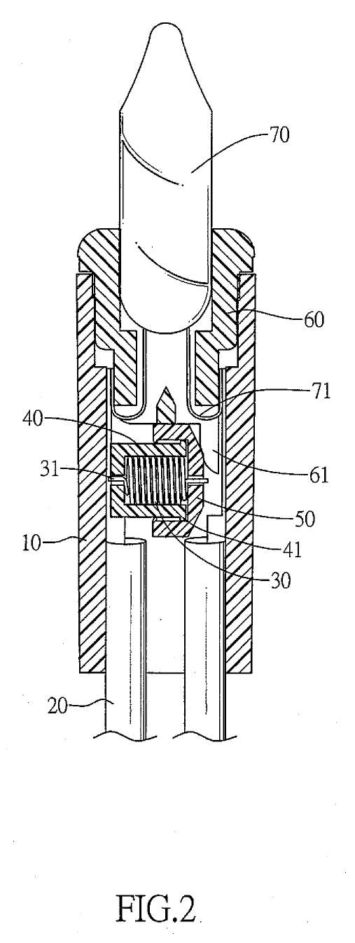

With reference to FIGS. 1 and 2, a lamp in accordance with the present invention comprises a socket (10), two electrodes (20), a shunt compression spring (30), an insulating casing (40), a sliding lid (50), a bulb holder (60) and a bulb (70).

The socket (10) is hollow, has an opening (11), a bottom and an inner surface and may further have two tracks (12). The tracks (12) are formed oppositely on the inner surface of the socket (10).

The electrodes (20) protrude from the bottom of the socket (10).

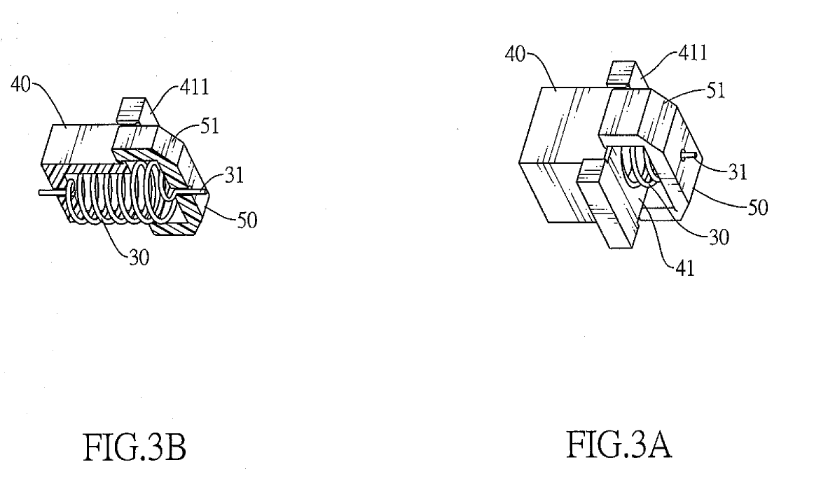

The shunt compression spring (30) is mounted in the socket (10) and has an axis, a diameter and two electric contacting ends (31). The electric contacting ends (31) contact selectively and respectively with the electrodes (20). With further reference to FIGS. 3B, 5B and 6B, each electric contacting end (31, 31′, 31″) may be a strip being parallel to the axis of the shunt compression spring (30), a ring having an axis perpendicular to the axis of the shunt compression spring (30) and a coil being coaxial with the axis of the shunt compression spring (30) and having shorter diameter than the diameter of the shunt compression spring (30).

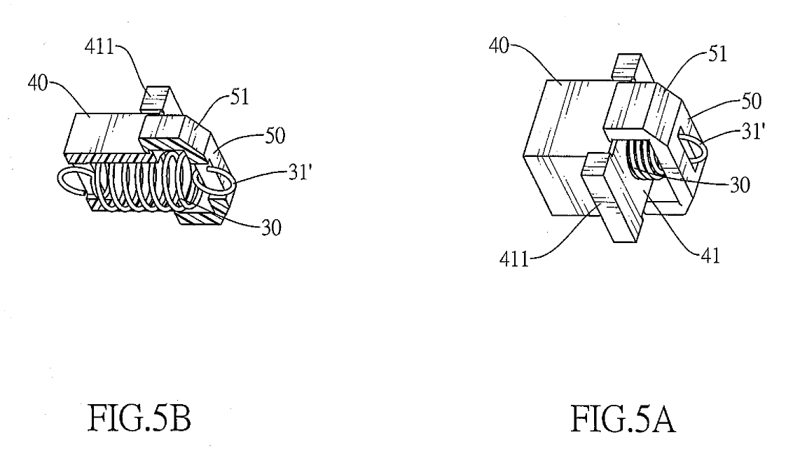

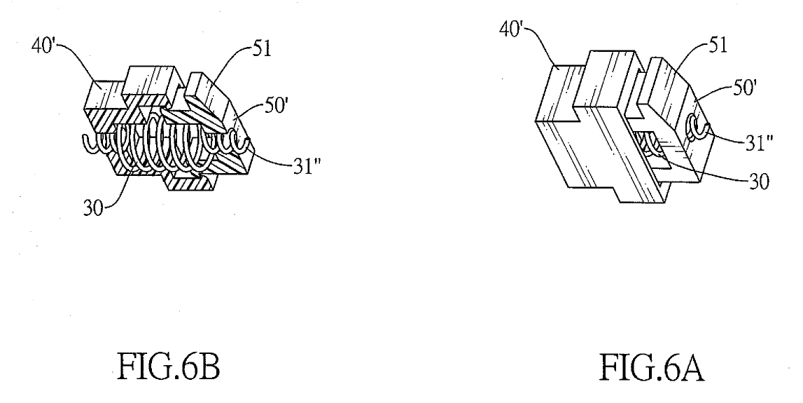

The insulating casing (40, 40′) covers the shunt compression spring (30) and has a first through opening and a second through opening. The first and the second through openings respectively expose the electric connecting ends (31) of the shunt compression spring (30), and the first through opening further exposes a segment of the shunt compression spring (30). With further reference to FIG. 6A, a diameter of a segment of the insulating casing (40′) near the first through opening of the insulating casing (40′) is larger than the diameter of the remaining segment of the insulating casing (40′) so the insulating casing (40′) is transverse T-shaped. In addition, with reference to FIGS. 3A and 5A, the insulating casing (40) may further have a flange (41) and two guide salients (411) when the socket (10) has the tracks (12). The flange (41) is formed on the first through opening of the insulating casing (40). The guide salients (411) are formed oppositely on the flange (41), correspond respectively to and are positioned movably in the tracks (12) of the socket (10) to allow the insulating casing (40, 40′) to be movable and removable in the socket (10).

The sliding lid (50, 50′) corresponds to the first through opening of the insulating casing (40, 40′), connects movably to the insulating casing (40, 40′) to cover the exposed segment of the shunt compression spring (30) and expose the electric contacting end (31) corresponding to the exposed segment of the shunt compression spring (30). Furthermore, the sliding lid (50, 50′) may be reversely C-shaped and may have two ends and an inclined surface (51). The two ends of the sliding lid (50, 50′) may be clasped movably on the flange (41) of the insulating casing (40, 40′) or in the first through opening of the insulating casing (40, 40′).

The bulb holder (60) is plugged in the socket (10), protrudes from the opening (111) of the socket (10), is hollow and has a protrusion (61). The protrusion (61) corresponds to and presses the inclined surface (51) on the sliding lid (50, 50′) matchingly to compress the shunt compression spring (30) and keep the electric contacting end (31) of the shunt compression spring (30) exposing through the sliding lid (50, 50′) from contacting with the corresponding electrode (20).

The bulb (70) is mounted in the bulb holder (60), protrudes from the bulb holder (60) and the opening (11) of the socket (10) and has two wires (71). The wires (71) protrude from the bulb (70) and pass oppositely through the bulb holder (60) to make electrical contact respectively with the electrodes (20).

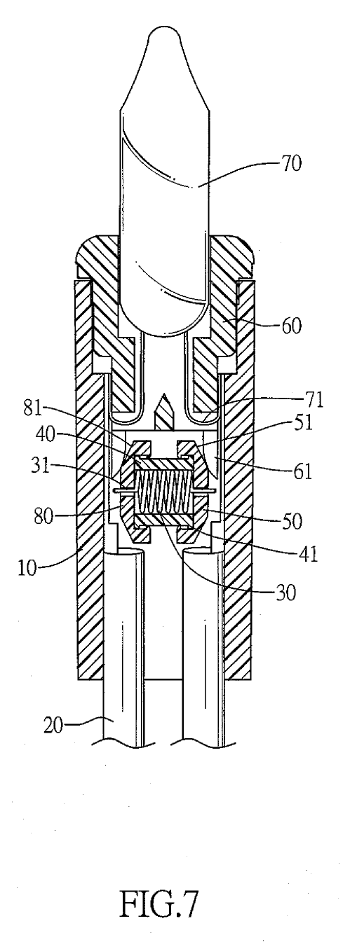

Moreover, with reference to FIG. 7, the present invention may further comprise another sliding lid (80), and the second through opening of the insulating casing (40) may expose another segment of the shunt compression spring (30) and may further have another flange (41), and the bulb holder (60) may further have another protrusion (61). The another sliding lid (80) connects movably to the insulating casing (40) opposite to the sliding lid (50), covers the another exposed segment of the shunt compression spring (30), exposes the electric contacting end (31) near the another exposed segment of the shunt compression spring (30), may have another inclined surface (81) and may be clasped movably on the another flange (41) of the insulating casing (40). The another protrusion (61) corresponds to and presses the another inclined surface (81) on the another sliding lid (80) to compress the shunt compression spring (30) and keep the electric contacting end (31) of the shunt compression spring (30) exposing through the another sliding lid (80) from contacting with the corresponding electrode (20).

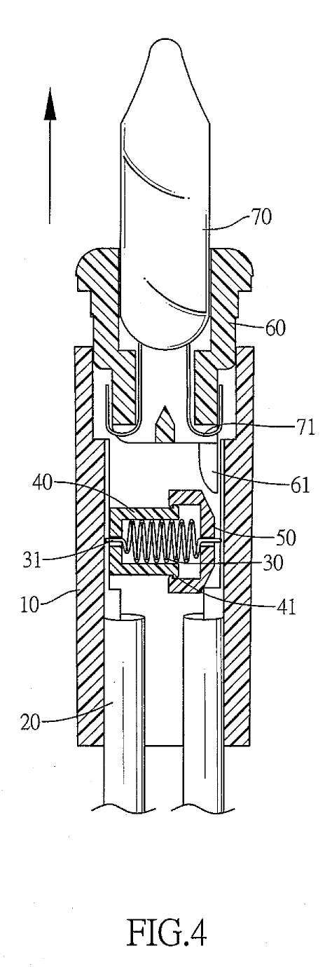

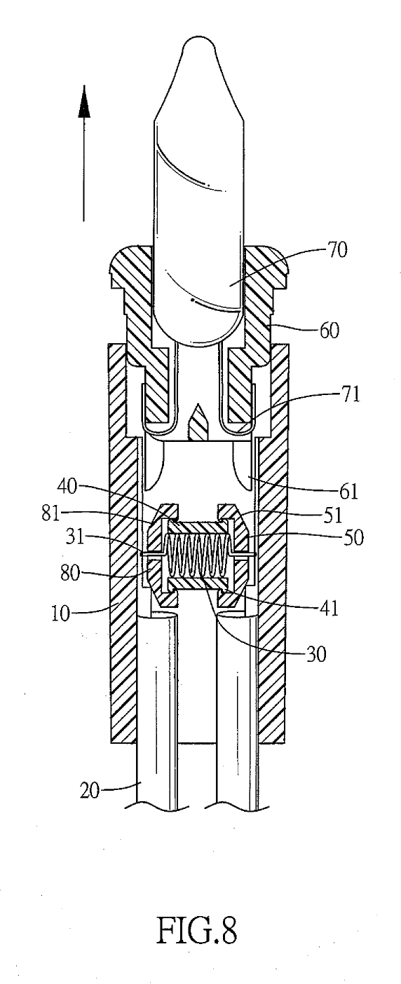

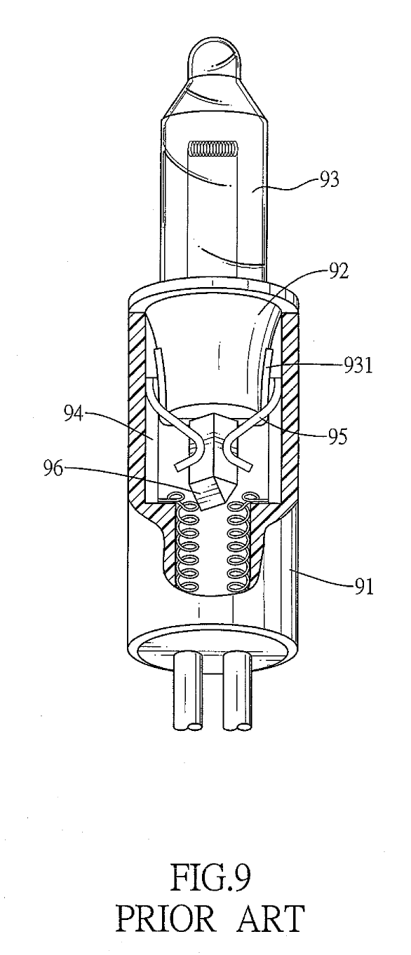

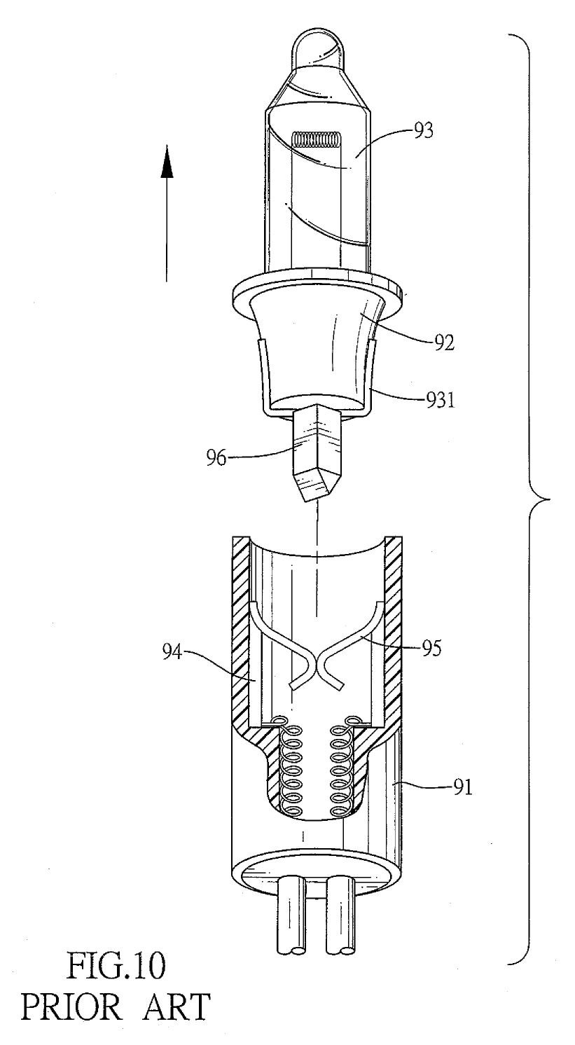

With further reference to FIGS. 4 and 8, when the lamp of the present invention is used in a light string and the bulb (70) and the bulb holder (60) are removed from the socket (10), the electric contacting end (31) of the shunt compression spring (30) kept from contacting with the corresponding electrode (20) by the protrusion (61) pressing the corresponding sliding lid (50, 80) will contact with the corresponding electrode (20) because the bulb holder (60) is not in the socket (10). Therefore, the electric connection of the light string will be still maintained by the contacted shunt compression spring (30) and the electrodes (20). Furthermore, the shunt compression spring (30) in the present invention is protected by the insulating casing (60) and the sliding lid (50) to prevent the shunt compression spring (30) from deforming by external force. Accordingly, the lamp of the present invention provides more reliable shunt element to keep the electric connection of the light string from being cut off.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A lamp with shunt compressing spring comprising:
a socket being hollow, having an opening, a bottom and an inner surface;
two electrodes protruding from the bottom of the socket;
a shunt compression spring mounted in the socket and having
an axis;
a diameter; and
two electric contacting ends contacting selectively and respectively with the electrodes;
an insulating casing covering the shunt compression spring and having
a first and a second through openings respectively exposing the electric connecting ends of the shunt compression spring, and the first through opening exposing a segment of the shunt compression spring connected to the second electric connecting ends;
a sliding lid corresponding to the first through opening of the insulating casing, connecting movably to the insulating casing to cover the exposed segment of the shunt compression spring and exposing the electric connecting end corresponding to the exposed segment of the shunt compression spring;
a bulb holder plugged in the socket, protruding from the opening of the socket, being hollow and having
a protrusion corresponding to and pressing the sliding lid matchingly to compress the shunt compression spring and keep the electric contacting end of the shunt compression spring exposing through the sliding lid from contacting with the corresponding electrode; and
a bulb mounted in the bulb holder, protruding from the bulb holder and the opening of the socket and having
two wires protruding from the bulb and passing oppositely through the bulb holder to make electrical contact respectively with the electrodes.

2. The lamp as claimed in claim 1 further comprising another sliding lid, wherein
the second through opening of the insulating casing further exposes another segment of the shunt compression spring;
the insulating casing further has two flanges formed respectively on the first and second through openings of the insulating casing;
the two sliding lids are clasped movably and respectively on the two flanges of the insulating casing; and
the bulb holder further has another protrusion, and the two protrusions of the bulb holder correspond respectively to and press the sliding lids to compress the shunt compression spring and keep the electric contacting ends of the shunt compression spring respectively from contacting with the electrodes.

3. The lamp as claimed in claim 1, wherein
the insulating casing further has
a flange formed on the first through opening of the insulating casing; and
the sliding lid is reversely C-shaped and has two ends clasped movably on the flange of the insulating casing.

4. The lamp as claimed in claim 1, wherein the sliding lid is reversely C-shaped and has two ends clasped movably in the first through opening of the insulating casing.

5. The lamp as claimed in claim 3, wherein
the socket further has two tracks formed oppositely on the inner surface of the socket; and
the insulating casing further has two guide salients formed oppositely on the flange, corresponding respectively to and positioned movably in the tracks of the socket.

6. The lamp as claimed in claim 1, wherein the sliding lid further has an inclined surface corresponding to the protrusion of the bulb holder to allow the protrusion matchingly pressing the sliding lid.

7. The lamp as claimed in claim 2, wherein each sliding lid further has an inclined surface and the inclined surfaces of the two sliding lid correspond respectively to the protrusions of the bulb holder to allow the protrusions matchingly pressing the sliding lids.

8. The lamp as claimed in claim 3, wherein the sliding lid further has an inclined surface corresponding to the protrusion of the bulb holder to allow the protrusion matchingly pressing the sliding lid.

9. The lamp as claimed in claim 4, wherein the sliding lid further has an inclined surface corresponding to the protrusion of the bulb holder to allow the protrusion matchingly pressing the sliding lid.

10. The lamp as claimed in claim 5, wherein the sliding lid further has an inclined surface corresponding to the protrusion of the bulb holder to allow the protrusion matchingly pressing the sliding lid.

11. The lamp as claimed in claim 1, wherein each electric contacting end is a strip being parallel to the axis of the shunt compression spring.

12. The lamp as claimed in claim 2, wherein each electric contacting end is a strip being parallel to the axis of the shunt compression spring.

13. The lamp as claimed in claim 3, wherein each electric contacting end is a strip being parallel to the axis of the shunt compression spring.

14. The lamp as claimed in claim 4, wherein each electric contacting end is a strip being parallel to the axis of the shunt compression spring.

15. The lamp as claimed in claim 5, wherein each electric contacting end is a strip being parallel to the axis of the shunt compression spring.

16. The lamp as claimed in claim 1, wherein each electric contacting end is a ring having an axis perpendicular to the axis of the shunt compression spring.

17. The lamp as claimed in claim 3, wherein each electric contacting end is a ring having an axis perpendicular to the axis of the shunt compression spring.

18. The lamp as claimed in claim 5, wherein each electric contacting end is a ring having an axis perpendicular to the axis of the shunt compression spring.

19. The lamp as claimed in claim 1, wherein each electric contacting end is a coil being coaxial with the axis of the shunt compression spring and having shorter diameter than the diameter of the shunt compression spring.

20. The lamp as claimed in claim 4, wherein each electric contacting end is a coil being coaxial with the axis of the shunt compression spring and having shorter diameter than the diameter of the shunt compression spring.
